(19) United States
(12) Patent Application Publication
(10) Pub. No.: US 2003/0111192 A1
(43) Pub. Date: Jun. 19, 2003

(54) Plate element and method of producing a plate element

(75) Inventor: Dieter Brinkkotter, Halle (DE)

Correspondence Address: Barnes & Thornburg, 9th Floor, 750 17th Street, N.W., Washington, DC, 20006, US

(73) Assignee: Holz-Speckmann GmbH

(21) Appl. No.: 10/305,099

(22) Filed: Nov. 27, 2002

(30) Foreign Application Priority Data
Nov. 30, 2001 (DE) 101 58 730.9-25
Nov. 2, 2002 (DE) 02 024 343.2

(51) Int. Cl. E05D 15/16

(52) U.S. Cl. 160/201; 160/236

(57) ABSTRACT

A plate element (2), particularly for garage doors, comprises a frame (10) consisting of wood, in which a filling element (11) is accommodated. The filling element (11) is essentially formed of a foamed material, on both sides a cover layer (13) made of wood being arranged around the filling element (11). The plate-shaped filling element (11) is framed between two pressure distributor plates (12). The plate element (2) according to the invention has a particularly high heat insulation at a low weight and can be used particularly for garage doors and facade coverings. In addition, a method is provided of producing a plate element (2) according to the invention.

The present invention relates to a plate element, particularly for garage doors or sectional doors, a frame consisting of wood being provided in which a filling element is accommodated, and on both sides a cover layer being arranged around the filling element, and to a method of producing a plate element.

Plate elements are known, in the case of which a frame is produced of wood and frames a filling element. The filling element consists of, for example, three mutually connected layers which, on the edge side, are glued to the frame. Such multi-layer filling plates may be profiled on the surface in order to give the plate element a special exterior design and, for example, provide patterns in a garage door. These known plate elements have the disadvantage that their manufacturing requires high expenditures. The inserting, gluing-together and pressing-together of the frame components and of the filling plates is relatively time-consuming. In addition, the heat insulation of these plate elements is low because the filling plates can only be constructed to be of a limited thickness in order to minimize the weight of the plate elements. Specifically when using standard frames and normal tension springs and drives for garage doors, the weight of the movable plate elements should not be too high.

Furthermore, from German Patent Document DE 39 01 683, a wall element is known which has improved sound insulation values and, in the case of which, an exterior plate is fastened to a framework-type frame on two opposite sides. Mineral fiber plates for the heat and sound insulation are inserted into the frame. Although these wall elements are suitable for interior walls situated in a covered fashion, they can be used in the visible area only to a limited extent because gypsum plaster board or particle boards are provided as exterior plates.

It is therefore an object of the invention to provide a plate element, particularly for garage or sectional doors, which has an attractive appearance and a relatively good heat insulation. In addition, it should be possible to produce the plate element in a simple and cost-effective manner.

This object is achieved by means of a plate element having the characteristics of claim 1 and by means of a method of producing a plate element having the characteristics of claim 12.

When a filling element of a foamed material is provided in the frame and a cover layer of wood is arranged on both sides around the filling element, the volume-related weight of the plate element is considerably reduced because the filling element made of foamed a material has a clearly lower specific weight than wood. In addition, the filling element made of a foamed material provides a good heat insulation which is considerably better than that of wood materials. Since the filling element is surrounded with a cover layer of wood on both sides, the filling element is protected against weather, and, in addition, the plate element has an attractive appearance because only the cover layers made of wood are visible from the outside. This also permits the use of high-quality wood which can be processed at a lower thickness, in order to minimize the material consumption of the relatively expensive and heavy wood material.

In this case, the plate-shaped filling element is accommodated between two pressure distributor plates or sealing layers which are constructed, for example, of a particle board. The cover layer made of wood can be connected comparatively poorly directly with the foamed material, particularly because, during the connecting, a high contact pressure is applied to the cover layer and considerable tensions occur during the contact pressing at the transition between the frame made of wood and the foamed filling element, which tensions may result in breaks. In order to prevent such phenomena, a pressure distributor plate is preferably arranged on both sides on the filling element so that the cover layer made of wood can be better connected with the frame and the filling element. In this case, the filling element and the pressure distributor plates can be glued particularly well to the frame on the edge side.

According to a preferred embodiment of the invention, the frame has an inwardly oriented projection of a reduced width, thus of a smaller width than the entire plate element, which projection is glued on both sides to a pressure distributor plate. The pressure distributor plates can be fixed on this projection, so that a particularly stable connection can be established between the frame and the pressure distributor plates which are not visible. The pressure distributor plates are preferably accommodated in a surrounding edge area in a form-locking manner in the frame, if required, while taking into account an adhesive layer.

When the cover layers made of wood close off in a laterally flush manner with the frame, a closed appearance of the plate element is obtained. In addition, the plate element may be constructed symmetrically with respect to a center plane, so that no warping and distortions occur at the plate element which would prohibit a durable installation.

In order to be able to better mutually connect the plate-shaped filling element, the pressure distributor plates and/or the cover layer made of wood, one connector layer respectively made of a nonwoven or similar material may be inserted. This layer may have a thin construction and is used only for a better adherence and as a bonding bridge between the individual layers and frames.

Instead of using the plate element in a garage door, it is conceivable to use the plate element as a facade element, particularly because the filling element considerably increases the heat insulation. Other usages of the plate element are also conceivable.

According to the invention, a garage or sectional door is also provided which is formed of several mutually connected plate elements. In this case, the individual plate elements are provided with tongue-and-groove profiles, which can be swivelled in one another, and can therefore be swivelled within a certain radius.

Furthermore, according to the invention, a method of producing a plate element is provided which has the following steps:

Gluing and pressing together a cover layer made of wood and a pressure distributor plate;

constructing a surrounding frame;

inserting a filling element into the frame;

arranging an already connected unit of a cover layer and a pressure distributor plate on both sides of the filling element;

gluing and pressing together the two units of the cover layer and the pressure distributor plate with the frame and the filling element.

The individual process steps are to be understood as a basic sequence and not as a purely chronological sequence. For example, for producing at plate element, two units of the cover layer and the pressure distributor plate and optionally the fame and the filling element can first be provided with glue and then a unit of the cover layer and the pressure distributor plate can be placed on a depositing device; then the frame with or without the filling element can be put on and, optionally after the insertion of the filling element, the second unit of the cover layer and the pressure distributor plate can be placed in the glued condition on the frame. Subsequently, the preassembled unit can then be pressed together. According to the invention, a two-step method is selected, in which first a cover layer and a pressure distributor plate are connected to form a unit. Two such units are then connected with the frame and the filling element. This two-step further development of the method according to the invention can naturally be varied within wide ranges within the realm of the individual steps. Thus, it is, for example, up to the person skilled in the art to decide whether or where the application of the glue precisely takes place. In each case, it is ensured as a result of the two-step implementation of the method that the cover layer made of wood is in each case durably connected with the pressure distributor plate and it is prevented that, because of temperature and weather influences, the cover layer is detached from the pressure distributor plate and is warped. The pressure distributor plate provides a plane alignment of the cover layer.

The pressure distributor plate is preferably at least partially glued to the frame. This ensures a particularly stable connection of the preassembled unit.

The pressing-together of the units of the cover layer and the pressure distributor plate with the frame and the filling element, if possible, takes place in at least two directions extending perpendicular to one another; for example, by means of two pressure cheeks which press laterally upon the frame, so that gaps are avoided between the individual components. Particularly in the case of protrusions at the frame, which are to be glued to an end section of two pressure distributor plates, the pressing should also take place in the direction of the protrusions, so that a gap is avoided and a form closure and a durable glued connection is established between the frame and the front edges of the unit of the pressure distributor plate and the cover layer.

In the following, the invention will be explained in detail by means of an embodiment with respect to the attached drawings.

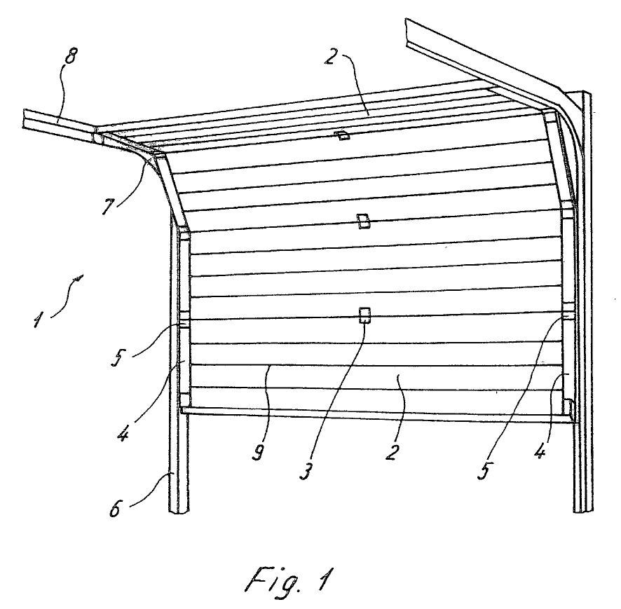

FIG. 1 is a perspective view of a garage door with plate elements according to the invention;

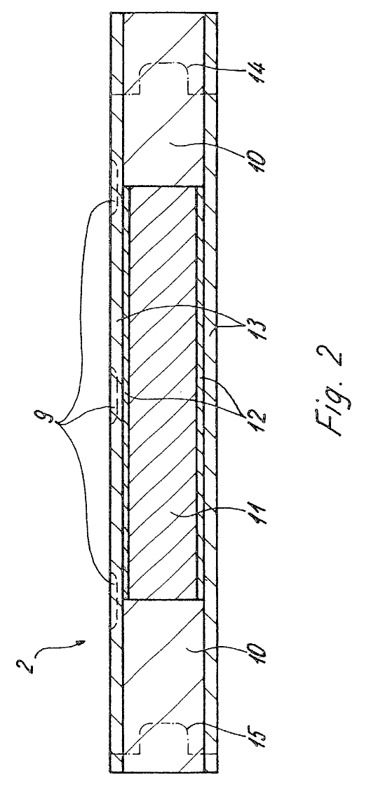

FIG. 2 is a sectional view of a plate element of FIG. 1; and

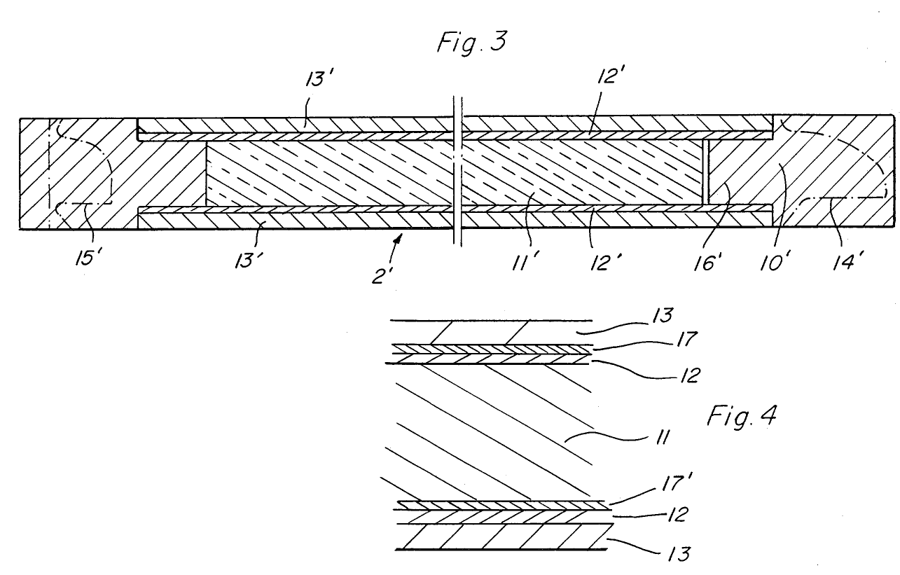

FIG. 3 is a sectional view of a plate element according to another embodiment.

FIG. 1 illustrates a garage door 1 which is formed of several plate elements 2 mutually connected by means of hinges 3. On their opposed sides, the plate elements 2 are each connected with a strip 4 on which guiding elements 5 are mounted. The guiding elements 5 may be formed, for example, by runners guided in a rail 6. The vertical rail 6 leads into a rounded guideway 7 which is then adjoined by a horizontal guideway 8 in the ceiling area of a garage.

The garage door 1 can be moved by way of a drive, which is not shown in detail, and can be opened and closed as required. Conventional drives and controls can be used for this purpose.

On their exterior side, the plate elements 2 are provided with a groove 9 which, for visual purposes, is cut into the exterior side of the plate element 2. It is also possible to provide other types of patterns on the plate elements 2.

FIG. 2 is a sectional view of a plate element 2. The plate element 2 comprises a two-sided or surrounding frame 10 made of wood in which a filling plate 11 of polyurethane foam, polypropylene foam or of another filling material is accommodated. The filling element 11 is surrounded on both sides by a pressure distributor plate 12 which is constructed as a particle board. The frame 10 as well as the pressure distributor plates 12 are pasted to a cover layer 13 made of wood, particularly glued, which cover plate has a smoothly constructed outer surface, into which grooves 9 can, however, be cut.

The individual plate elements 12 have a tongue profile 14 on the frame 10 and a groove profile 15 at the opposed longitudinal edge which can be inserted into one another. The shape of the tongue profile 14 and of the groove profile 15 may be selected such that the plate elements 2 can be swivelled in one another, in which case, in the fitted-together condition of the plate elements 2, if possible, a form closures is established, in order to achieve a good heat insulation.

Between the filling plate 11 and the particle board 12 as well as the particle board 12 and the cover layer 13, a nonwoven material may be provided for a better adherence. The frame 10, the filling plate 11, the particle board 12 as well as the cover layer 13 can be mutually connected by means of pasting agents known per se, such as glue.

FIG. 3 shows a plate element 2′ which can also be used in the case of a garage or sectional door.

A frame 10′, in turn, surrounds a center plate-shaped filling element 11′ made of a light heat-insulating material. The filling element 11′ is surrounded by two pressure distributor plates 12′ as well as by two cover layers 13′ made of wood connected therewith. At the side pointing toward the outside, on two longitudinal edges, a tongue profile 14′ as well as a groove profile 15′ can be constructed at the frame 10′, so that several plate elements 2′ can be lifted or swivelled in one another.

On each side, the frame 10′ is in each case formed of a beam, which has an integrally constructed protrusion 16′ and is produced, for example, by sawing, planing or cutting. It is also possible to form the frame 10′ of a beam and a strip which are connected, for example, glued to one another, in which case, a profiling for a mechanical connection may also be provided. The strip having a narrower width than the width of the beam will then take over the function of the “protrusion” at the frame 10′. By the fastening of the pressure distributor plates 12′ at the frame 10′, the filling element may also be held only mechanically in the frame 10′ by means of clamping forces.

In the illustrated embodiment, a particle board 12 is used as the pressure distributor plate. It is also conceivable to provide different materials for this plate. Furthermore, other materials of a low weight and a good heat insulation can also be used for the filling element. The plate elements 2 and 2′ according to the invention can also be used generally as partitions, other walls, as flooring materials, gates or doors.

For producing the plate elements 2 and 2′, a cover layer made of wood is first glued to a pressure distributor plate and pressed together and, if required, still sawed to the correct size or cut into several pieces. Subsequently, a surrounding frame is constructed of several beams and a filling element is inserted into the frame. Then two already connected units of the cover layer and the pressure distributor plate are arranged on both sides of the filling element. This construction with the two units of the cover layer and the pressure distributor plate, the frame and the filling element are then glued together and pressed together.

A two-step process is selected in which first, in each case, a cover layer and a pressure distributor plate are connected to form a unit. Two such units are then connected with the frame and the filling element. As a result of the two-stage implementation of the method, it is ensured that the cover layer made of wood is durably connected with the pressure distributor plate and it is prevented that the cover layer detaches from the pressure distributor plate as a result of temperature and weather influences and is warped.

1. Plate element (2), particularly for garage or sectional doors, having a frame (10) consisting of wood, in which a filling element (11) is accommodated, the filling element (11) being formed essentially of a foamed material or a soft-fiber or glass fiber insulation plate, and the plate-shaped filling element (11) being accommodated between two pressure distributor plates (12), a cover layer (13) made of wood, on both sides, being connected with one pressure distributor plate (12) respectively.

2. Plate element according to claim 1, characterized in that the pressure distributor plates (12), on the edge side, are glued to the frame (10).

3. Plate element according to claim 1 or 2, characterized in that the frame (10) has an inward oriented protrusion of a reduced width which is glued on both sides to a pressure distributor plate (12).

4. Plate element according to claim 3, characterized in that the pressure distributor plates (12), on the edge side, are form-lockingly fitted into the frame (10).

5. Plate element according to one of claims 1 to 4, characterized in that the pressure distributor plates (12) are each constructed of a particle board or of a plywood panel.

6. Plate element according to one of claims 1 to 5, characterized in that the cover layers (13) laterally closed off flush with the frame (10).

7. Plate element according to one of claims 1 to 6, characterized in that the frame (10) is provided with a groove profile on a first longitudinal edge and is provided with a tongue profile on an opposed second longitudinal edge.

8. Plate element according to one of claims 1 to 7, characterized in that a connector layer, for example, of a nonwoven material, is inserted between the plate-shaped filling element (11) and/or the pressure distributor plates (12) and the cover layers (13).

9. Plate element according to one of claims 1 to 8, characterized in that the foamed material of the filling plate (11) is formed of polyurethane foam, polypropylene foam or another foamed material.

10. Plate element according to one of claims 1 to 9, characterized in that the plate element is constructed as a facade element.

11. Garage or sectional door, characterized in that it is formed of several mutually connected plate elements (2) according to one of the preceding claims, and groove and tongue profiles (14, 15) are constructed on the plate elements (2) which profiles can be swivelled in one another.

12. Method of producing a plate element (2), particularly for a garage door, characterized by
gluing and pressing together a cover layer (13) made of wood and a pressure distributor plate (12),
constructing a surrounding frame (10),
inserting a filling element (11) into the frame (10),
arranging an already connected unit of a cover layer (13) and a pressure distributor plate (12) on both sides of the filling element (11),
gluing and pressing together the two units of the cover layer (13) and the pressure distributor plate (12) with the frame (10) and the filling element (11).

13. Method according to claim 12,
characterized in that the pressure distributor plate (12) is glued at least partially to the frame (10).

14. Method according to claim 12 or 13,
characterized in that the pressing together of the units consisting of the cover layer (13) and the pressure distributor plate (12) with the frame (10) and the filling element (11) takes place by means of two pressing plates, which press on the cover layers (13), and by means of two pressing cheeks which press laterally onto the frame (10).
